(19) United States
(12) Patent Application Publication
(10) Pub. No.: US 2005/0089208 A1
(43) Pub. Date: Apr. 28, 2005

(54) System and method for generating digital images of a microscope slide

(76) Inventors: Rui-Tao Dong, Mission Viejo, CA (US); Usman Rashid, Irvine, CA (US); Jack A. Zeineh, Fullerton, CA (US)

Correspondence Address: KAYE SCHOLER LLP, 425 PARK AVENUE, NEW YORK, NY, 10022-3598, US

(21) Appl. No.: 10/897,941

(22) Filed: Jul. 22, 2004

Related U.S. Application Data
(60) Provisional application No. 60/489,769, filed on Jul. 22, 2003.

(51) Int. Cl. G06K 9/00; G06K 9/40

(52) U.S. Cl. 382/133; 382/255

(57) ABSTRACT

An improved system and method for obtaining images of a microscope slide are provided. In one embodiment, a focus camera includes an optical sensor that is tilted relative to the focal plane of a scanning camera. A scan of a target region is performed, and multiple overlapping images of the target region are captured from a plurality of x-y positions. Each image contains information associated with multiple focal planes. Focus information is obtained from the images, and a desired-focus position is determined for the target region based on the focus information. The scanning camera then captures an image of the target region from the desired-focus position. This procedure may be repeated for selected regions on the microscope slide and the resulting images of the respective regions are merged to create a virtual slide.

This application claims the benefit of U.S. Application No. 60/489,769, filed on Jul. 22, 2003, assigned to the assignee of the present invention and incorporated by reference herein in its entirety.

### FIELD OF THE INVENTION

The invention relates generally to a system and method for generating images of a microscope slide, and more particularly, to a system and method for obtaining focus information to be used in scanning a microscope slide.

### BACKGROUND OF THE INVENTION

A virtual microscope slide typically comprises digital data representing a magnified image of a microscope slide. Because the virtual slide is in digital form, it can be stored on a medium, e.g., in a computer memory, and can be transmitted over a communication network, such as the Internet, an intranet, etc., to a viewer at a remote location.

Virtual slides offer advantages over traditional microscope slides. In some cases, a virtual slide can enable a physician to render a diagnosis more quickly, conveniently and economically than is possible using traditional microscope slides. For example, a virtual slide may be made available to a remote user, e.g., a specialist in a remote location, over a communication link, enabling the physician to consult with the specialist and provide a diagnosis without delay. Alternatively, the virtual slide can be stored in digital form indefinitely, for later viewing at the convenience of the physician or specialist.

Typically, a virtual slide is generated by positioning a microscope slide (which contains a sample for which a magnified image is desired) under a microscope objective, capturing one or more images covering all, or a portion, of the slide, and then combining the images to create a single, integrated, digital image of the slide. It is often desirable to divide a slide into multiple regions, and generate a separate image for each region, because in many cases the entire slide is larger than the field of view of a high-power (e.g., 20×) objective. Additionally, the surfaces of many tissues are uneven and contain local variations that make it difficult to capture an in-focus image of an entire slide using a fixed z-position. As used herein, the term z-position refers the coordinate value of the z-axis of a Cartesian coordinate system. Accordingly, existing techniques typically obtain multiple images representing various regions on a slide, and combine the images into an integrated image of the entire slide.

One current technique for capturing digital images of a slide is known as the start/stop acquisition method. According to this technique, multiple target points on a slide are designated for examination. A high-power objective (e.g., 20×) is positioned over the slide. At each target point, the z-position is varied and images are captured from multiple z-positions. The images are then examined to determine a desired-focus position. If one of the images obtained during the focusing operation is determined to be sufficiently in-focus, it is selected as the desired-focus image for the respective target point on the slide. If none of the images is in-focus, the images are analyzed to determine a desired-focus position, the objective is moved to the desired-focus position, and a new image is captured. In some cases, a first sequence of images does not provide sufficient information to determine a desired-focus position. In such event, it may be necessary to capture a second sequence of images within a narrowed range of z-positions before a desired-focus image is acquired. The multiple desired-focus images (one for each target point) obtained in this manner may be combined to create a virtual slide.

Another approach used to generate in-focus images for developing a virtual slide includes examining the microscope slide to generate a focal map, which is an estimated focus surface created by focusing a (high-power) scanning objective on a limited number of points on the slide. Then, a scanning operation is performed based on the focal map. Current techniques construct focal maps by determining desired-focus information for a limited number of points on a slide. For example, such systems may select from 10 to 20 target points on a slide and use a high-power objective to perform a focus operation at each target point to determine a desired-focus position. The information obtained for those target points is then used to estimate desired-focus information for any unexamined points on the slide.

Start/stop acquisition systems, as described above, are relatively slow, because the microscope objective is often required to perform multiple focus-capture operations for each designated target point on the slide. In addition, a high-power objective's field-of-view is limited; therefore, the number of points for which desired-focus information is directly obtained may be a relatively small portion of the entire slide.

Existing techniques for constructing focal maps also have several disadvantages. First, as described above, the use of a high-power objective to obtain desired-focus data for a given target point is relatively slow. Second, generating a focal map from a limited number of points on the slide can create inaccuracies in the resulting focal map. Tissue on a slide often does not have a uniform, smooth surface. Many tissue surfaces contain variations that vary across small distances. If a point on the surface of the tissue that has a defect or a significant local variation is selected as a target point for obtaining focus information, the deviation can affect estimated values for desired-focus positions throughout the entire focal map.

### SUMMARY OF THE INVENTION

The invention provides an improved system and method for obtaining images of selected regions on a microscope slide. In an aspect of the invention, a focus camera captures a plurality of images of a target region. Each image covers a respective area that includes at least a portion of the target region. Additionally, each image contains information associated with multiple focal planes. In one embodiment, the sensor of the focus camera is positioned so that its focal plane is tilted (positioned at a non-zero angle) relative to the focal plane of a main, scanning camera. In one example, the sensor in the focus camera is tilted (positioned non-orthogonally) relative to the optical axis of the optics between the microscope slide and the sensor, and with respect to the slide itself, while the sensor of the main camera is parallel to the slide. The focus camera itself may be tilted to tilt the sensor, or the sensor within the camera may be tilted, or both. The focus camera performs a scan of the target region, and multiple overlapping images of the target region are captured from a plurality of locations, or x-y positions. Focus information is obtained from the images, and a desired-focus position for the scanning camera is determined for the target region based on the focus information. The scanning camera then captures an image of the target region from the desired-focus position. This procedure may be repeated for selected regions on the microscope slide, and the resulting images of the respective regions are merged to create a virtual slide.

Accordingly, in one embodiment, one or more images of an area comprising at least a portion of a target region on a microscope slide are captured, each image containing information corresponding to a plurality of focal planes, and a position of a microscope slide for imaging the area is determined, based, at least in part, on the one or more images. The one or more images may include at least two overlapping images of the target region. An additional image of the target region may be captured based on the position. The one or more images may be captured by a first sensor having a first image plane, and the additional image may be captured by a second sensor having a second image plane, the first sensor being tilted relative to the second image plane. A virtual slide representing the microscope slide may be generated based, at least in part, on the additional image. One or more image characteristics at one or more of the focal planes may be analyzed, and the position determined based, at least in part, on the one or more image characteristics. The image characteristics may include, for example, texture energy, entropy, contrast, and/or sharpness.

The desired-focus position may be determined by identifying multiple sub-regions within the target region, dividing each of the one or more images into sub-images corresponding to respective sub-regions, examining one or more of the corresponding sub-images for at least one sub-region to determine a focus value for that respective sub-region, and determining the position based, at least in part, on one or more focus values of that respective sub-region. For each sub-region, one or more image characteristics relating to the one or more corresponding sub-ima ges may be analyzed, and a focus value for the sub-region may be determined based, at least in part, on the one or more image characteristics. The focus values may be determined using interpolation techniques or curve-fitting techniques, for example.

In a related embodiment, a system for generating images of a target region on a microscope slide is provided, comprising a microscope stage to hold a microscope slide. The system further comprises an objective comprising an objective lens to receive light interacting with the surface of the microscope slide. A first camera is provided comprising a first image sensor to collect a first portion of the light. The first image sensor is positioned at a first angle relative to the optical path of the first portion of the light. A second camera is provided comprising a second image sensor to collect a second portion of the light. The second image sensor is positioned at a second angle relative to the optical path of the second portion of the light. The first angle is different from the second angle. The system may also include a beam splitter disposed in the path of the light between the objective and the first and second cameras to distribute the first portion of the light to the first camera and the second portion of the light to the second camera.

In another embodiment, a system for generating images of a target region on a microscope slide is provided, comprising a microscope stage to hold a microscope slide, an objective comprising an objective lens to receive light interacting with the surface of the microscope slide, and a camera comprising an image sensor to collect the light. The image sensor is positioned at an oblique angle relative to the optical path of the light.

In still another embodiment, a system for processing images of a target region on a microscope slide is provided, comprising a sensor to capture one or more images of an area comprising at least a portion of a target region on a microscope slide Each image contains information corresponding to a plurality of focal planes. A processor is coupled to the sensor. The processor is programmed to determine a position of a microscope slide for imaging the area, based, at least in part, on the one or more images.

### BRIEF DESCRIPTION OF THE DRAWINGS

These and other features and advantages of the invention will be apparent to those skilled in the art from the following detailed description of preferred embodiments, taken together with the accompanying drawings, in which:

FIG. 1 is a block diagram of an imaging system that may be used to obtain magnified images of a microscope slide, in accordance with an embodiment of the invention;

FIG. 2A is a schematic illustration of a portion of a focus camera comprising an optical sensor positioned to receive incoming light, in accordance with an embodiment of the invention;

FIG. 2B is a schematic illustration of a portion of a focus camera comprising an optical sensor positioned to receive incoming light, in accordance with another embodiment of the invention;

FIG. 3A illustrates a first example of a focus window and scanning window within a field-of-view of a microscope objective, in accordance with one embodiment of the invention;

FIG. 3B-3D illustrate other examples of focus windows and scanning windows;

FIG. 4 is a flowchart depicting an example of a method for obtaining images of a microscope slide, in accordance with an embodiment of the invention;

FIG. 5 illustrates schematically a defined section on a microscope slide, in accordance with an embodiment of the invention;

FIG. 6A is a schematic representation of a projection of a focus window onto a portion of a slide, including a target region, in accordance with an embodiment of the invention;

FIG. 6B is a schematic representation of a region on a microscope slide and a field captured via a focus window, in accordance with an embodiment of the invention;

FIG. 6C is a schematic representation of a projection of a focus window onto a portion of a slide, including a target region, in accordance with an embodiment of the invention;

FIG. 6D is a schematic representation of a region on a microscope slide and a field captured via a focus window, in accordance with an embodiment of the invention;

FIG. 6E is a schematic representation of an optical sensor, and a region on a microscope slide in a first position and in a second position, in accordance with an embodiment of the invention;

FIG. 7 illustrates a region on a microscope slide and multiple micro-regions within the region, in accordance with an embodiment of the invention;

FIG. 8 illustrates a speed curve that may be applied to control the motion of a microscope stage, in accordance with an embodiment of the invention; and

FIG. 9 is a flowchart depicting an example of a method for obtaining images of a microscope slide, in accordance with an embodiment of the invention.

### DETAILED DESCRIPTION OF THE PREFERRED EMBODIMENTS

A virtual microscope slide typically comprises digital data representing a magnified image of all, or a portion of, a microscope slide. Because the virtual slide is in digital form, it can be stored on a medium, e.g., in a computer memory, and can be transmitted over a communication network, such as the Internet, an intranet, etc., to a viewer at a remote location.

An improved system and method are provided for obtaining magnified images of a microscope slide for use in constructing a virtual slide. In an aspect of the invention, a focus camera captures a plurality of images of a target region. Each image covers a respective area that includes at least a portion of the target region. Additionally, each image contains information associated with multiple focal planes. In one embodiment, the sensor of the focus camera is positioned so that its focal plane is tilted relative to the focal plane of a main, scanning camera. In one example, the sensor in the focus camera is tilted (positioned non-orthogonally) relative to the optical axis of the optics between the microscope slide and the sensor, and with respect to the slide itself, while the sensor of the main camera is parallel to the slide. The focus camera itself may be tilted to tilt the sensor, or the sensor within the camera may be tilted, or both. The focus camera performs a scan of the target region, and multiple overlapping images of the target region are captured from a plurality of locations, or x-y positions. Focus information is obtained from the images, and a desired-focus position for the scanning camera is determined for the target region based on the focus information. The scanning camera then captures an image of the target region from the desired-focus position. This procedure may be repeated for selected regions on the microscope slide, and the resulting images of the respective regions are merged to create a virtual slide.

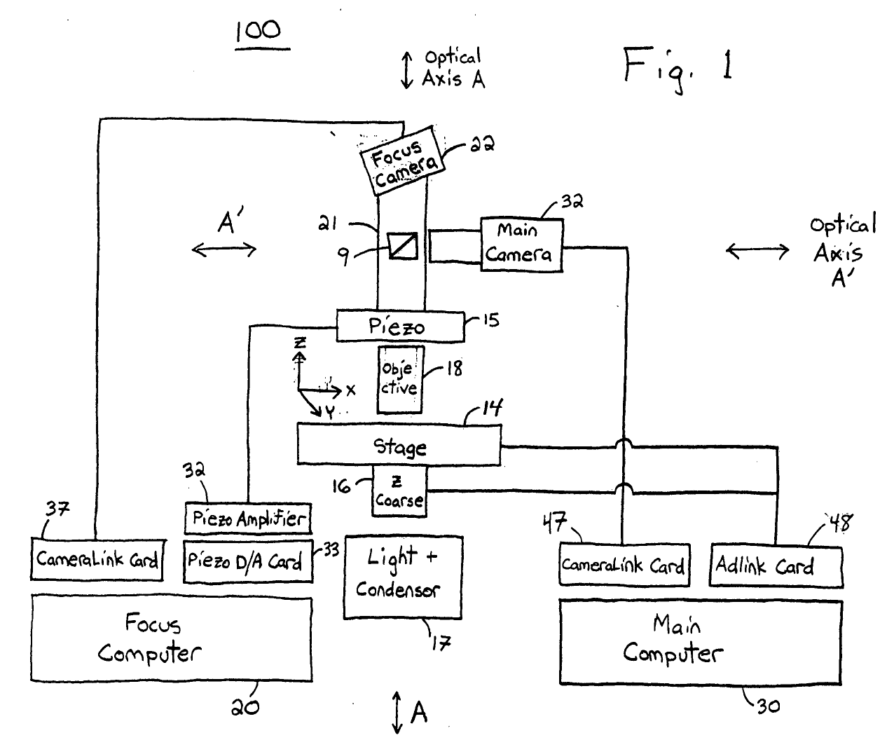

FIG. 1 is a block diagram of an imaging system 100 that may be used to obtain magnified images of a microscope slide, in accordance with an embodiment of the invention. System 100 includes an objective 18 (including an objective lens), a focus camera 22, a main camera 32 and a computer-controlled microscope stage 14. A microscope stage 14 is movable in the x, y, and z directions and is robotically controllable by mechanically coupling x, y, and z translation motors to the stage platform through control circuitry 16. A suitable illumination source 17 is disposed beneath stage 14 and is also translationally movable beneath the stage in order to shift the apparent illumination source with respect to a specimen on microscope stage 14. Both the translational motion of stage 14 and intensity of the illumination source 17 are controllable under software program control operating as an application on, e.g., main computer 30. A condensor collects light produced by illumination source 17 and directs it toward the sample.

In one embodiment, stage movement control system 16 comprises motors for controlling stage 14 in the x, y, and z directions, along with appropriate motor driver circuitry for actuating the motors. As used herein, the x and y directions refer to vectors in the plane in which stage 14 resides. The mechanical apparatus and electronic control circuitry for effecting stage movement are preferably implemented to include some form of open or closed-loop motor positioning servoing such that stage 14 can be either positioned with great precision, or its translational movement can be determined very accurately in the x, y, and z directions.

When stage movement control system 16 is configured to operate in a closed-loop, position feedback information can be recovered from the motor itself, or from optical position encoders or laser interferometer position encoders, if enhanced precision is desired. Closed-loop servo control of stage motion allows the stage position to, be determined with great accuracy and insures that translation commands are responded to with high precision, as is known in the art. Thus, a command to translate the stage 50 microns in the positive x direction will result in the stage moving precisely 50 microns in +x direction, at least to the mechanical resolution limits of the motor system.

If the system is configured to operate semi-closed-loop or open-loop, stage control is not dependent on feedback per se, but it is at least necessary to precisely define where the motors controlling the stage were told to go.

Position encoders (not shown) may be provided to transmit signals indicating the position of stage 14 to focus camera 22 and/or to main camera 32. This arrangement enables the camera(s) to capture images at desired positions even while stage 14 is in continuous motion. For example, the position encoders may monitor the distance traversed by stage 14 and transmit a predetermined signal every 5 microns. Focus camera 22 and/or main camera 32 may be configured to capture an image in response to a set or a subset of electrical signals received from the positioning feedback devices, e.g., rotary or linear scale encoders, thereby producing images of a microscope slide at regular intervals. In one example, a linear encoder mounted along the scan axis of the slide provides absolute positioning feedback to the control system to generate accurate periodic signals for image capture. These periodic signals act as external triggers to the camera for high speed consistent sectional image capture This technique overcomes many positioning error issues such as following errors (following errors are defined as the difference of position from the electrically commanded position to the actual mechanical response of the positioning system to the commanded position) associated with the true transformation of electrical control signals to the actual mechanical position of the slide relative to the image plane of the camera. This technique may also safeguard against the periodic degradation of the mechanical hardware caused by the repeated use of lead screws, loose couplings, friction, environmental issues, etc.

Alternatively, the camera(s) may be configured to capture images at regular time intervals, or based on pulses transmitted to the motors. For example, control pulses sent to a stepper or a linear motor may be used. These could be raw transistor-transistor logic (TTL) signal pulses or amplified control pulses fed through an electronic counter circuitry generating an absolute or relative output pulse to trigger the camera for image capture, for example. A TTL step and direct signal generated through a stepper controller pulse generator may be fed back through the encoder feedback channel to the controller. In this arrangement, the integrated real-time ‘pulse counter’ counts pulses to generate a periodic pulsed output for the camera. This technique may be used in conjunction with motor directional signal output as an input to the controller for bidirectional or unidirectional output trigger pulse control to capture images based on the direction of motion. Alternatively, clockwise and counter-clockwise operating modes may be used for motor control and to feed the directional pulses back to the controller for periodic camera triggering synchronized with motion.

Microscope system 100 comprises at least one objective lens 18 that can be moved into the microscope optical path such that a magnified image of the specimen is generated. Examples of robotically controlled microscopy systems suitable for use in connection with the present invention include the Olympus BX microscope system equipped with a Prior H101 remotely controllable stage. The Olympus BX microscope system is manufactured and sold by Olympus America Inc., located in Melville, N.Y. The Prior H101 stage is manufactured and sold by Prior Scientific Inc., located in Rockland, Mass. Other similar computerized stages may be used, such as those manufactured and sold by Ludl Electronics Products Ltd. of Hawthorne, N.Y.

In one embodiment, piezo 15 performs a focusing operation by causing small excursions of objective 18 in the z direction in response to signals received from piezo amplifier 32. Piezo amplifier 32 receives control signals from focus computer 20 via piezo D/A card 32, and in response, controls the movement of piezo 15.

Microscope system 100 includes a beam splitter 9 that distributes light received through objective 18 to focus camera 22 and to main camera 32. In one embodiment, the field-of-view of objective 18 is partitioned into at least two sub-fields, or windows. The beam splitter directs a first portion of the light to focus camera 22, and a second portion of the light to main camera 32.

Focus camera 22 is optically coupled to microscope system 100 (e.g., optically coupled to a microscope tube 21) to capture diagnostic-quality images of microscopic tissue samples disposed on sample stage 14. In one embodiment, focus camera 22 may include an area sensor; alternatively, focus camera 22 may include a line sensor.

Focus camera 22 is preferably a high resolution, high-speed, black and white digital camera. Images generated by focus camera 22 are transmitted via a cameralink card 37 to focus computer 20, which applies image processing techniques to analyze the images. Cameralink card 37 functions as an interface between focus camera 22 and focus computer 20. Optionally, focus computer 20 generates and transmits focus information to main computer 30.

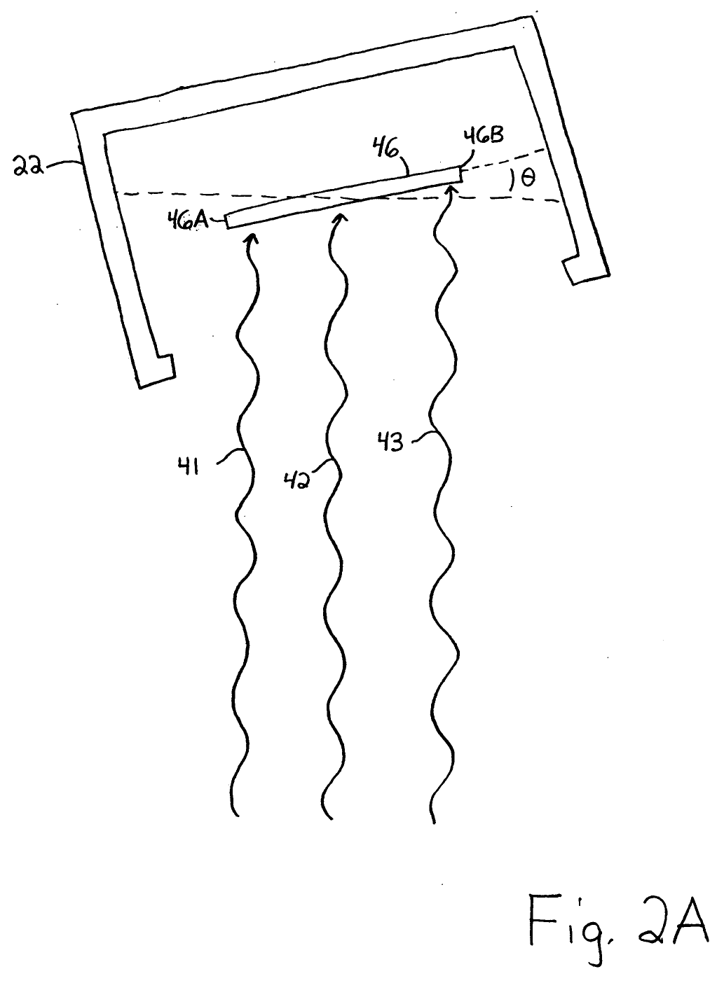

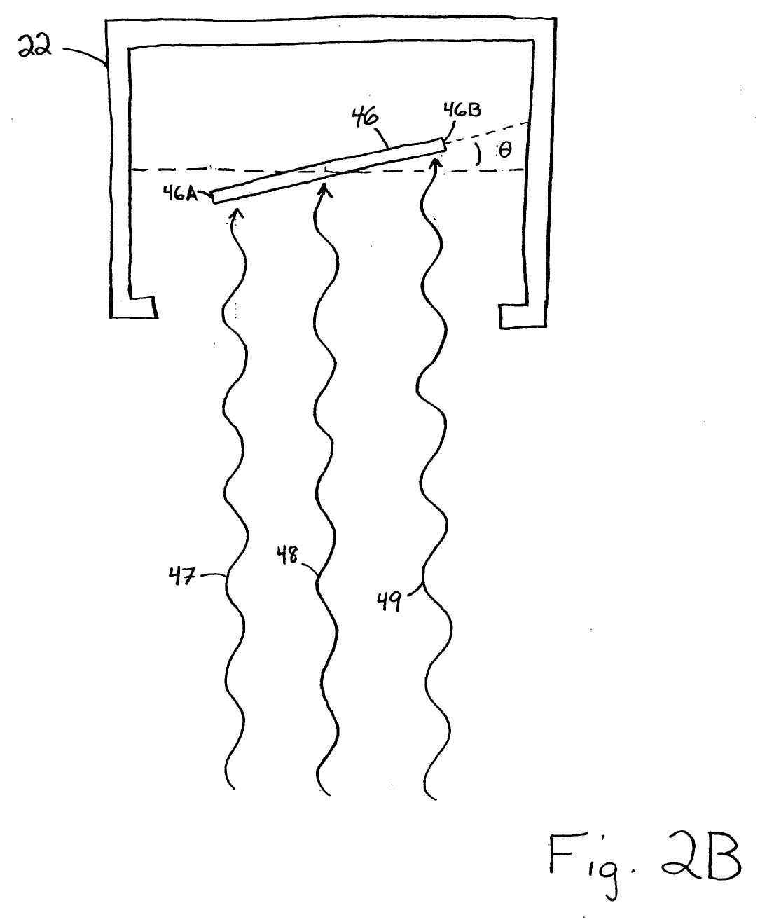

In accordance with an embodiment of the invention, focus camera 22 is positioned such that its optical sensor is tilted relative to the focal plane at which main camera 32 captures images. In one example, this may be accomplished by tilting focus camera 22 itself, as shown in FIG. 1 and in FIG. 2A. Focus camera 22 may be a Basler A202 km-OC, available from Basler AG, Ahrensburg, Germany. The Basler A202 km-OC, configured without microlenses, facilitates operation of the camera in a tilted position. In another example, the position of the optical sensor within focus camera 22 may be adjusted, as shown in FIG. 2B. In yet another example, additional optical components such as a barrel lens and prism, may be positioned in the path of the light to alter the path of the incoming light, creating or increasing the tilting effect. The Basler A202 k with microlenses, or the JAI CV-M4CL+ camera, manufactured and sold by the JAI Group located in Copenhagen, Denmark, may be used with a barrel lens and prism.

By way of illustration, FIG. 2A shows a portion of focus camera 22 comprising an optical sensor 46 positioned to receive incoming light, represented schematically by lines 41-43. For ease of illustration, refraction of the light by the objective is not shown in FIG. 2A, but would be apparent to a person skilled in the art. Focus camera 22 itself is tilted at an angle θ relative to a plane orthogonal to the optical path of the received light; consequently, the optical sensor 46 is also tilted at the same angle θ. For example, the optical sensor 46 may be positioned, at a 30 degree angle from the orthogonal plane. It should be noted that 30 degrees is merely an example, and that other angles may be used. Because of the tilt, the lower end 46A of the sensor 46 is closer to the sample than the upper end 46B. The difference in distance may result in the two ends of sensor 46 imaging z-positions on the sample that are about 30 microns apart, for example. As a result, images generated by focus camera 22 contain information associated with different z-positions, which correspond to different focal planes of main camera 32. In this illustrative embodiment, each of lines 41-43, when detected by optical sensor 46, represents a different z-position and therefore corresponds to a different focal plane of main camera 32. The angle θ may be determined based on several factors, including the desired focal range, the size of the sensor, and the magnification of the optical train of the focus system, for example. The desired focal range depends in part on the amount of variation present on the surface of the sample. Greater surface variations on the sample typically require a greater focal range and a larger angle θ.

FIG. 2B shows an alternative configuration, wherein sensor 46 is tilted within focus camera 22. Also in FIG. 2B, for ease of illustration, refraction of the light by the objective is not shown.

Both the resolution and depth-of-field of focus camera 22 may be determined in part by the wavelength of received light. At shorter wavelengths, the camera's resolution may increase, and its depth-of-field may decrease, thereby improving the results of any focus operation performed. Accordingly, a blue filter may be introduced in the optical path of focus camera 22 to retrieve the blue components of the incoming light and improve the camera's performance. This filtering may be accomplished in other ways as well, such as by using a three-chip camera or another device capable of retrieving the blue components of the incoming light, for example. A blue filter may also reduce the effects of chromatic aberrations, because the color range is reduced.

Referring again to FIG. 1, focus computer 20, implemented as a small platform computer system, such as an IBM-type x86 personal computer system, provides data processing and platform capabilities for hosting an application software program suitable for developing the necessary command and control signals for operating selected components of microscope system 100. Focus computer 20 may be coupled to one or more components of microscope system 100 through an interface (not shown), such as a serial interface, a Peripheral Component Interconnect (PCI) interface or any one of a number of alternative coupling interfaces, which, in turn, defines a system interface to which the various control electronics operating the microscope system are connected. Focus computer 20 may also include specialized software or circuitry capable of performing image processing functions such as, e.g., obtaining measurements of texture energy entropy, contrast, sharpness, etc.

A main, scanning, camera 32 is optically coupled to microscope system 100 (e.g., to microscope tube 21) to capture diagnostic-quality images of microscopic tissue samples disposed on the sample stage 14. In one embodiment, main camera 32 may include an area sensor; alternatively, main camera 32 may include a line sensor. Referring to FIG. 1, it should be noted that axis A associated with focus camera 22, and axis A′ associated with main camera 32, represent the same optical axis of the system.

Main camera 32 is preferably a high resolution, color, digital camera operating at a high-resolution and a high data rate. In one embodiment, for example, a JAI CV-M7CL+camera may be used; however, other cameras of comparable quality and resolution may also be used. Images captured by main camera 32 are directed via cameralink card 47 to main computer 30.

Main computer 30 provides data processing and platform capabilities for hosting an application software program suitable for developing the necessary command and control signals for operating selected components of system 100, including stage 14 and main camera 32. In one embodiment, main computer 30 may be implemented by a computer system similar to that used for focus computer 20. Adlink card 48 controls the motion of stage 14 in response to control signals received from main computer 30. Cameralink card 47 functions as an interface between main computer 30 and main camera 32. Main computer 30 may be coupled to one or more components of microscope system 100 through an interface (not shown), such as a serial interface, a proprietary interface or any one of a number of alternative coupling interfaces. Main computer 30 also comprises software or circuitry capable of performing a variety of image processing functions including, e.g., software registration of images. In an alternative embodiment, main camera 32 (or focus camera 22) may be implemented by a camera having an internal computational engine (referred to as a “smart camera”), as is known in the art, which provides the functionality of main computer 30 (or of focus computer 20). Such smart cameras are also commercially available, such as the DVT Legend 544, manufactured and sold by DVT Sensors, Inc. of Duluth, Ga.

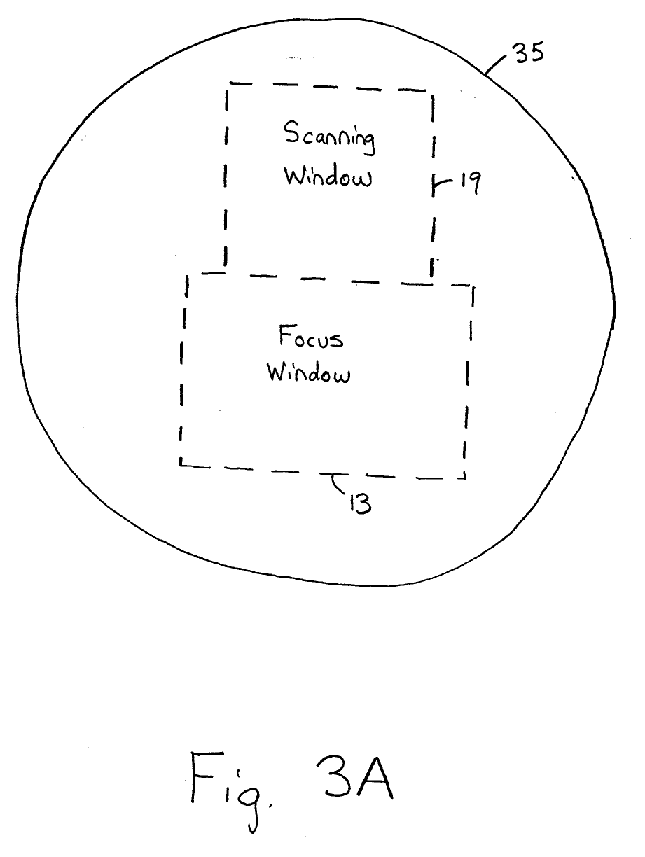

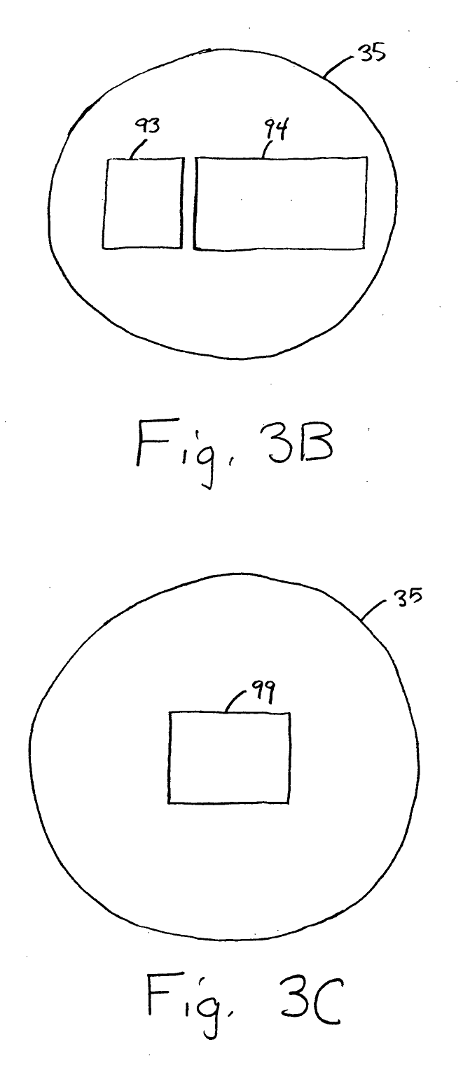

As mentioned above, light received through objective 18 is selectively distributed by beam splitter 9 to focus camera 22 and to main camera 32. FIG. 3A illustrates a field 35 representing a field-of-view of objective 18, in accordance with one embodiment. A focus window 13 and a scanning window 19 are defined within field 35. The definition of fields 13, 19 may be performed by focus computer 20. Focus camera 22 receives a first portion of the light and generates image from the light associated with focus window 13. Main camera 32 receives a second portion of the light and generates images from the light associated with scanning window 19. This arrangement makes it possible to utilize focus camera 22 to capture image information that may be used to generate focus information from one part of a target region, and main camera 32 to collect light for generating images from another part of the target region, simultaneously.

Focus camera 22 contains a sensor capable of generating an image of a region on the microscope slide captured via focus window 13. One or more images of a respective region received via focus window 13 are utilized to generate focus information for the region before main camera 32 captures an image of the region via scanning window 19. Main camera 32 contains a sensor capable of generating an image of a region via scanning window 19. In the embodiment illustrated in FIG. 3A, focus window 13 is larger than scanning window 19; however, in alternative embodiments, the size ratio between the two windows may vary. Additionally, although in the illustrative embodiment scanning window 19 is adjacent to focus window 13, in alternative examples scanning window 19 may be separated from focus window 13 within the field-of-view of objective 18. The positioning of focus window 13 and scanning window 19 with the field-of-view of objective 18 may also vary. FIGS. 3B-3D show alternative sizes and configurations for the focus and scanning windows. In FIG. 3B, focus window 93 and scanning window 94 are positioned side-by-side. In FIG. 3C, window 99 functions both as a focus window and as a scanning window. In FIG. 3D, focus window 96 is separated from scanning window 97. The gap between focus window 96 and scanning window 97 may be larger, smaller, or equal to the height of scanning window 97. It should also be noted that focus window 96 may be smaller, equal in size, or larger than scanning window 97. If focus window 96 is smaller in size than scanning window 97, focus camera 22 may receive one or more subsampled images of a particular region; however, in some cases a subsampled image may provide sufficient information for calculating focus information using the techniques described herein.

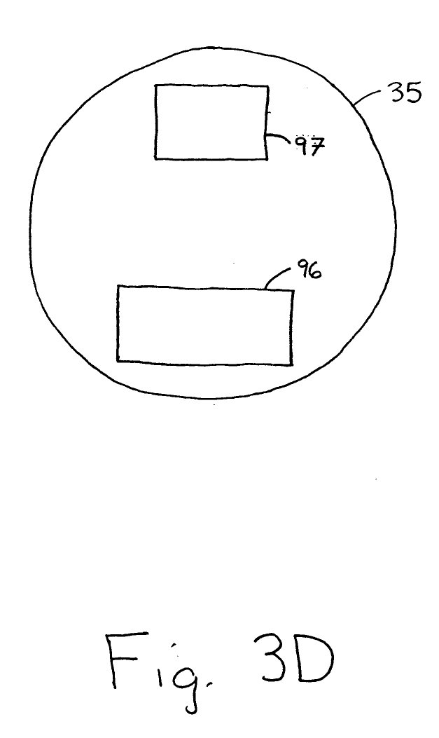

As discussed above, existing methods for obtaining images of a microscope slide, including the start-stop acquisition method and various focal map techniques, are relatively slow. In accordance with one aspect of the invention, an improved system and method for obtaining images of a microscope slide are provided. FIG. 4 is a flowchart depicting an example of a method for obtaining images of a microscope slide, in accordance with one embodiment. At step 610, multiple overlapping images of a target region are captured. Each image contains information associated with multiple focal planes. At step 620, the images are examined and focus information is obtained from the images. At step 630, a desired-focus position for the region is determined based on the focus information. At step 635, the z-position of stage 14 is adjusted and main camera 32 captures an image of the target region from the desired-focus position. The image of the target region may be combined with images of other regions on the slide to generate a virtual slide at step 670. These steps are explained in more detail below.

As discussed above, because the optical sensor within focus camera 22 is tilted relative to the focal plane of main camera 32 (see FIGS. 2A-B), each image generated by focus camera 22 contains information associated with multiple focal planes of main camera 32, each at a different z-position. Focus computer 20 analyzes the images to obtain focus information associated with the target region and determines a desired-focus position for the region, based on image characteristics such as, for example, texture energy, entropy, contrast, sharpness, etc. A number of techniques for analyzing images based on such image characteristics are well-known in the art and are discussed further below.

After a desired-focus position is determined, the x-y position of stage 14 is subsequently adjusted to place the target region within scanning window 19, the stage is moved to the desired-focus position, and main camera 32 captures an image of the target region.

It should be noted that although in this embodiment adjustments to x-, y-, and z-positions are achieved by moving stage 14, in alternative embodiments x-, y-, and z-position adjustments may be achieved by moving objective 18, or by other methods.

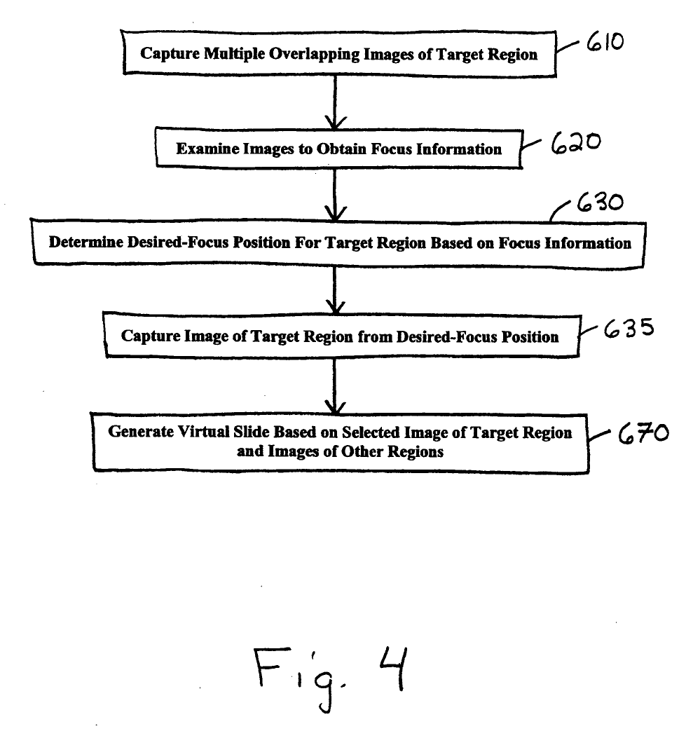

In one embodiment, main computer 30 defines a section of a microscope slide for scanning. The section may be defined manually to include an area of interest (such as a malignancy) on the surface of a sample. Alternatively, the section may be defined automatically by, e.g., software residing in main computer 30. For example, FIG. 5 illustrates schematically a 4000-by-3000 micron section 305 on a microscope slide. Main computer 30 then divides section 305 into multiple regions. The dimensions of the regions may be defined based, e.g., on the size of scanning window 19. For example, if scanning window 13 corresponds to a region on the microscope slide that is 400 microns wide in the x-direction and 300 microns wide in the y-direction, main computer 30 may divide section 305 into one hundred 400 micron-by-300 micron regions. Referring to FIG. 5, section 305 is divided into ten rows of ten 400-by-300 micron regions.

Microscope system 100 scans section 305 row-by-row. In this embodiment, stage 14 moves continuously during the scan; however, in alternative embodiments, stage 14 may stop at selected points, e.g., at selected imaging positions. By capturing images while stage 14 is in motion, focus information can be generated at a faster rate than by existing techniques. Main computer 30 causes stage 14 to move such that focus window 13 progresses steadily across row 984 in the +x direction, beginning at region 382. Alternatively, scanning may be performed using other patterns, such as, e.g., scanning in the −x direction. For example, in the configuration shown in FIG. 3B, because focus window 93 is defined to be to the left of scanning window 94, scanning is performed in the −x direction.

While stage 14 is in motion, focus camera 22 generates multiple, overlapping images of the regions in row 984 by capturing images at intervals smaller than the width of the regions. In this example, focus camera 22 captures an image every 50 microns. The distance representing the interval between images is a function of several considerations, including the number of z-positions for which focus information is desired and the angle θ present in focus camera 22. As discussed above, these factors are affected by the desired focal range, the size of the sensor, and the magnification of the optical train of the focus system, for example. An additional factor influencing the interval between images is the depth-of-field of focus camera 22. As the camera's depth-of-field decreases, more images at different z-positions may be necessary to capture a sufficient amount of focus information. It should be noted that while row 984 is being scanned via focus window 13, scanning window 19 does not receive images of any regions in section 305; however, when a subsequent row (e.g., row 985) is scanned via focus window 13, scanning window 19 receives images of the immediately preceding row (e.g., row 984).

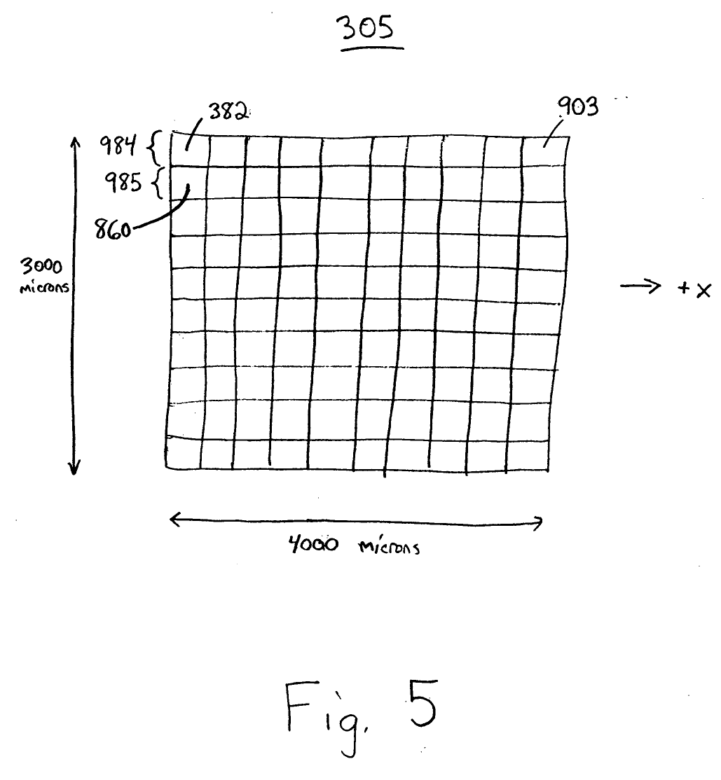

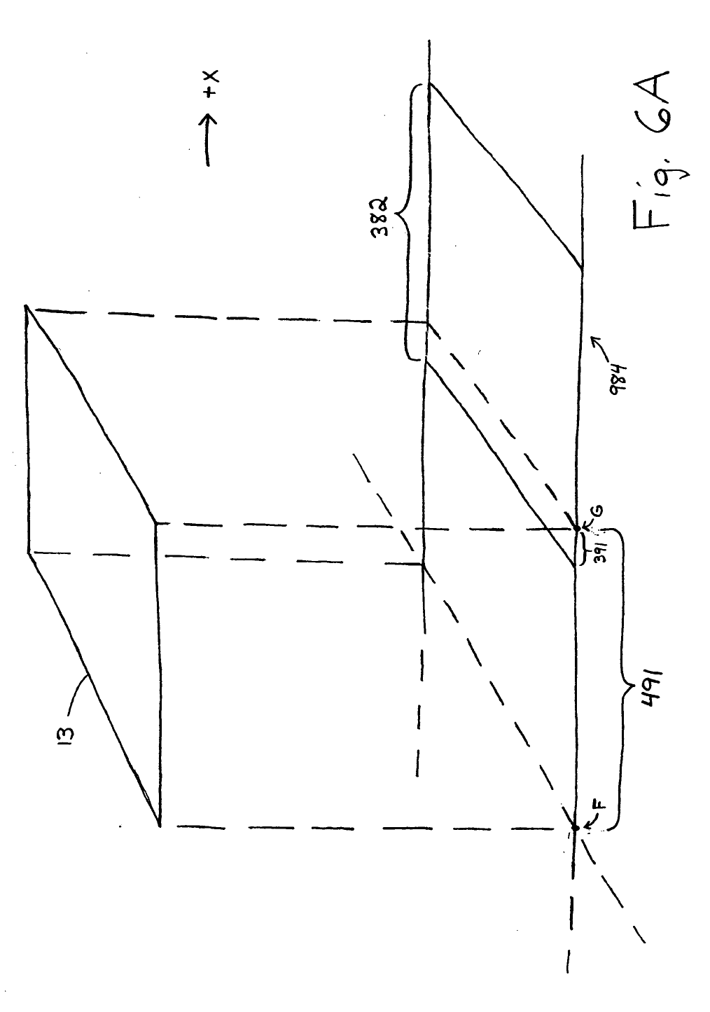

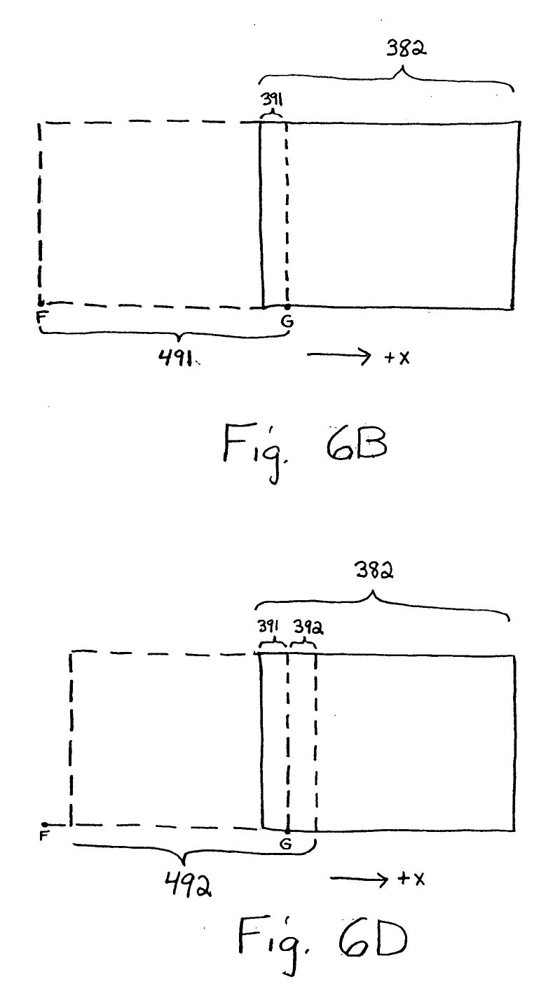

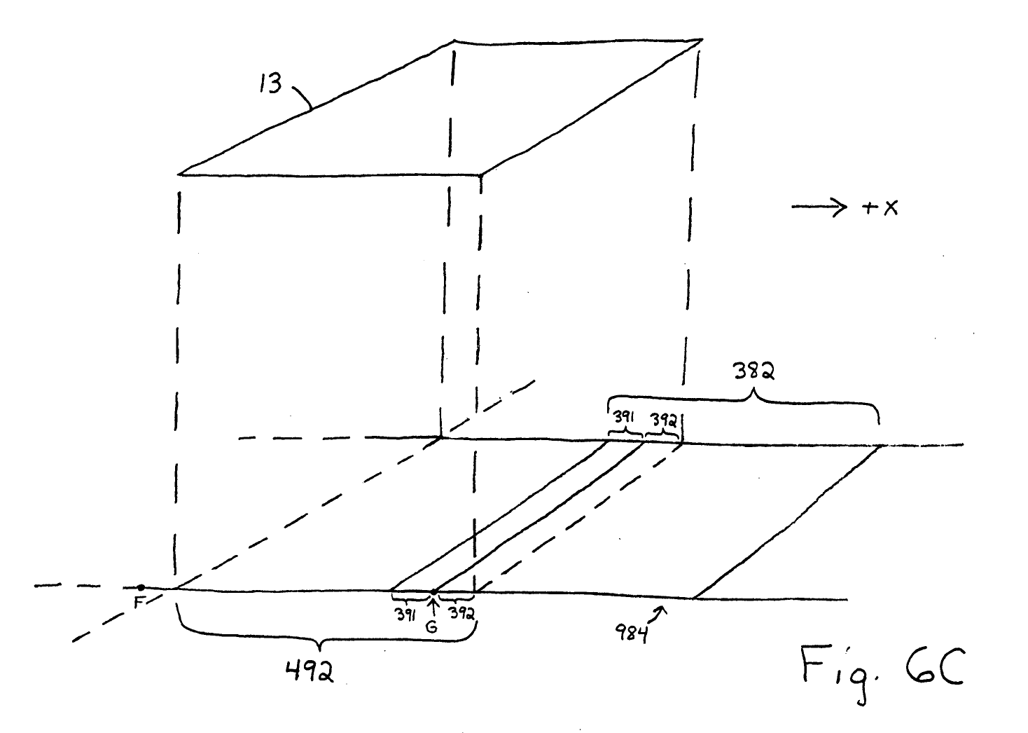

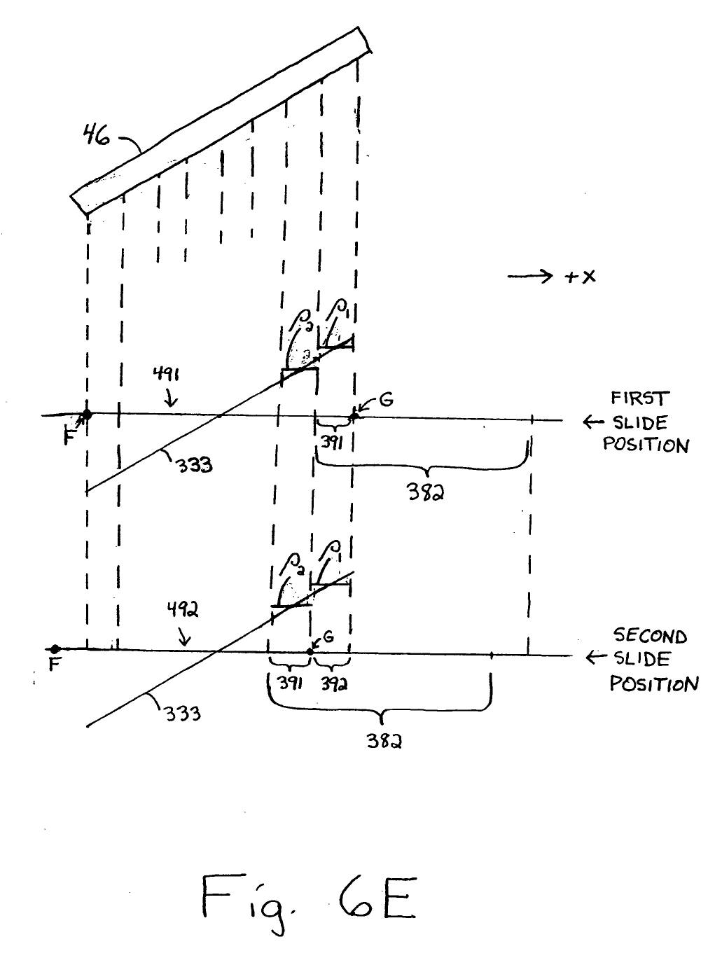

The scan may begin when region 382 first enters focus window 13 and continues until the last region in row 984 (i.e., region 903) is no longer in focus window 13. During the scan, focus camera 22 generates multiple overlapping images of the regions in row 984. FIGS. 6A-6E illustrate schematically the process by which multiple, overlapping images are captured by focus camera 22. FIG. 6A shows schematically a projection of focus window 13 onto the slide (represented by the dotted lines) at the moment a first image is captured, in accordance with an embodiment. The scan begins when the portion of first region 382 in row 984 enters the field-of-view of focus window 13. After focus window 13 has progressed +50 microns in the x-direction, a first image is captured by focus camera 22. Thus, the first image comprises an image of field 491, which extends from point F to point G and overlaps target region 382 in the area constituting micro-region 391. The first image includes micro-region 391 and an area on the microscope slide outside of target region 382. FIG. 6B shows a top view showing the relationship between target region 382 and field 491. The image information in the first image pertaining to micro-region 391 is associated with a z-position corresponding to a first focal plane p₁, of main camera 32, as shown in FIG. 6E and described in more detail below.

Preferably, the x-y position of stage 14 is adjusted continuously during the scan, and images are captured while stage 14 is in motion. In one embodiment, stage 14 may move at a constant speed; however, in an alternative embodiment, the speed of stage 14 may be varied.

After focus window 13 progresses an additional interval (e.g., 50 microns) in the +x direction, focus camera 22 captures a second image. FIG. 6C shows a projection of focus window 13 onto the slide after focus window 13 has shifted an additional +50 microns in the x-direction relative to field 491. The field-of-view of focus window 13 now comprises field 492, which includes micro-regions 391 and 392 of region 382. Focus camera 22 captures a second image, of field 492, and thus captures image information for micro-regions 391 and 392. As is shown in FIG. 6E, because the optical sensor within focus camera 22 is tilted, the image information in the second image pertaining to micro-region 392 is associated with the first focal plane ρ₁ of main camera 32, while the image information in the second image pertaining to micro-region 391 is associated with a second focal plane ρ₂ of main camera 32. FIG. 6D illustrates a top view of target region 382 and field 492. Field 492 is shifted +50 microns in the x-direction relative to field 491.

FIG. 6E is a schematic representation of two side views of target region 382 as the first and second images described above are captured by focus camera 22. For ease of illustration, the objective, and the effects of magnification and refraction of the light caused by the objective, are not shown, but would be apparent to a person skilled in the art. Plane 333 represents a focal plane of focus camera 22, across a plurality of z-positions. Planes ρ₁ and ρ₂ represent focal planes of main camera 32 corresponding to particular z-positions in the focal plane 333. The first slide position corresponds to FIG. 6A. In the first slide position, sensor 46 captures the first image of region 491, which extends from point F to point G and overlaps target region 382 in the area constituting micro-region 391. As described above, in this slide position, the image information pertaining to micro-region 391 is associated with the first focal plane ρ₁.

The second slide position corresponds to FIG. 6C, after focus window 13 has progressed an additional interval in the +x direction. In the second slide position, sensor 46 captures the second image of region 492, which overlaps target region 382 in micro-regions 391 and 392. In the second image, the image information pertaining to micro-region 392 is associated with the first focal plane ρ₁ of main camera 32, while the image information pertaining to micro-region 391 is associated with the second focal plane ρ₂ of main camera 32.

The scan continues across row 984 until the last region in the row (i.e., region 391) is no longer in focus window 13. As a result, multiple overlapping images of the regions in row 984 are produced, each representing a portion of row 984 that partly overlaps that of the previous image but which is shifted by +50 microns. The overlapping images of row 984 are transmitted to focus computer 20.

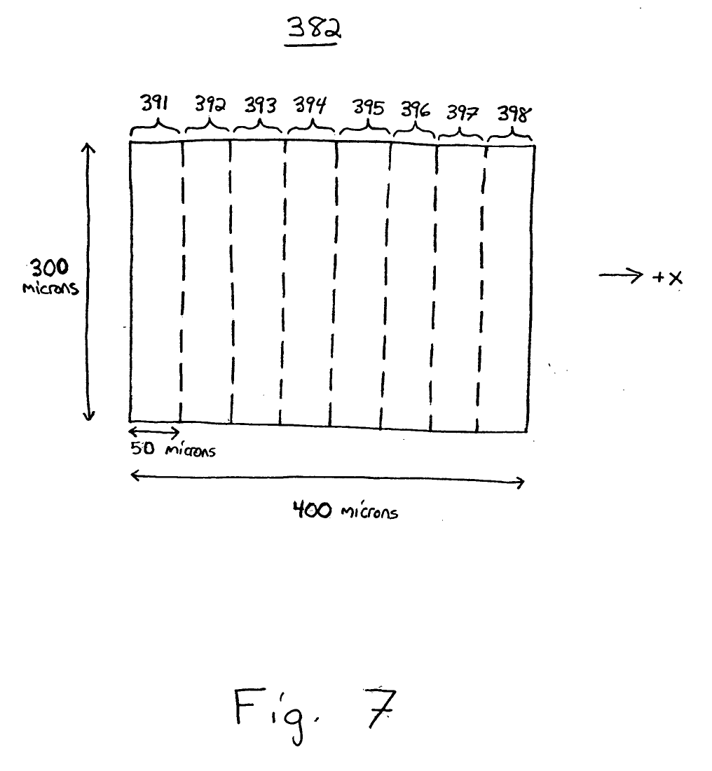

Focus computer 20 defines within each region in row 984 a plurality of micro-regions. The identification of micro-regions may be performed by, e.g., software residing in focus computer 20. In the illustrative example, each 400-by-300 micron region in row 984, e.g., region 382, is divided into eight micro-regions each 50 microns wide in the x-direction. FIG. 7 illustrates region 382 and eight micro-regions 391-398, each of which is 50 microns wide. Alternatively, microregions may be defined by dividing a region along both the x- and y- axes. For example, referring to FIG. 7, region 382 may alternatively be divided into eight portions along the x-axis, and into eight portions along the y-axis, creating microregions 50 microns wide by 37.5 microns high. Dividing microregions in such a fashion affords more robustness in cases of sparse tissue.

Focus computer 20 identifies a set of images that contain information pertaining to region 382. Then focus computer 20 defines within each image in the set one or more micro-images corresponding to micro-regions 391-398. Accordingly, in the illustrative example, up to eight micro-images corresponding to micro-regions 391-398 are defined within each image.

For each respective micro-region within region 382, focus computer 20 groups the associated micro-images of the same micro-region into a “stack.” For example, in the illustrative embodiment, each stack may contain up to eight micro-images (each micro-image representing a different focal plane). For example, a stack associated with micro-region 391 may contain eight micro-images associated with eight different focal planes ρ₁, ρ₂, . . . ρ₈ of main camera 32, respectively. Focus computer 20 performs a similar stacking operation for each region in row 984, and other rows.

Focus computer 20 examines the stack of micro-images associated with each micro-region to determine a desired-focus value for the micro-region based on image characteristics such as, for example, texture energy, entropy, contrast, sharpness, etc. A desired-focus value represents a z-position at which the analysis of the image characteristics indicates that an image having a desired focus may be obtained. Thus, for example, focus computer 20 examines the stack of micro-images associated with micro-region 391 and determines a desired-focus value for micro-region 391; focus computer does the same for each micro-region in each region of row 984.

Desired-focus values may be obtained using a variety of techniques known in the art. In one embodiment, one or more image processing techniques may be applied to the micro-images to obtain, from each micro-image, one or more measurements of focus quality. By way of example, a measure of overall entropy may be obtained for each micro-image and used as a measure of focus quality. A measure of overall entropy for a micro-image may be obtained by, e.g., compressing a micro-image and measuring the volume of data in the compressed image. In another example, a measure of texture energy may be obtained for each respective micro-image to obtain a value representing the focus quality of the micro-image. In yet another example, a contrast measurement may be obtained for each respective micro-image. Alternatively, edge detection techniques may be applied to a micro-image to obtain a value for sharpness. Other values relating to focus quality may also be measured. The measurements of focus quality thus obtained are analyzed to determine a desired-focus value for each micro-region. For example, in one embodiment, the stack of micro-images associated with a micro-region is examined, a micro-image having a maximum texture energy measurement is selected as the desired image, and a z-position associated with the desired image is selected as the desired-focus value. Alternatively, a curve-fitting algorithm may be applied to the various measurements of focus quality pertaining to a respective micro-region, and a desired-focus value for the micro-region may be interpolated. Other estimation techniques may also be used.

Focus computer 20 determines a desired-focus position for each respective region in row 984 based on the desired-focus values associated with the micro-regions within the region. For example, focus computer 20 determines a desired-focus position for region 382 based on the desired-focus values associated with micro-regions 391-398. In one embodiment, the desired-focus values associated with micro-regions 391-398 are averaged to determine a single desired-focus position for region 382.

After row 984 has been scanned by focus camera 22 (and desired-focus positions have been determined for each region in row 984), focus camera 22 repeats the procedure for the next row, e.g., row 985 in the instant case. Accordingly, main computer 30 adjusts the position of stage 14 to cause focus window 13 to scan across the regions in row 985, beginning with region 860.

As focus window 13 scans across row 985, scanning window 19 captures images of row 984, and main camera 32 sequentially generates images of each region in row 984 based on the desired-focus positions determined previously for each respective region. In one embodiment, main camera 32 captures images of each region in its entirety; main camera 32 thus captures images at a slower rate than focus camera 22. The desired-focus position determined previously for each respective region in row 984 is utilized to adjust the z-position of objective 18 when the region enters scanning window 19. Thus, for example, when region 382 enters scanning window 19, focus computer 20 causes objective 18 to move to the appropriate desired-focus position calculated for region 382, and scanning camera 32 captures an image at the desired-focus position. The procedure described herein may be repeated multiple times in order to obtain images of each region in section 305. After images are captured by scanning camera 32 for each region, the images are merged to create a virtual slide.

In the alternative example shown in FIG. 3D, focus window 97 may be separated from scanning window 96 by a distance greater than the height of the defined regions illustrated in FIG. 5. Accordingly, focus camera 22 may obtain additional focus information before main camera 32 captures images of a given row, thus improving the accuracy of the desired-focus position calculations. For example, referring to FIG. 5, focus camera 22 may obtain focus information pertaining to rows 984 and 985 before main camera 32 begins to scan row 984. The focus information concerning the regions in row 985 may be used in addition to the focus information pertaining to row 984 to determine desired-focus positions for the regions in row 984. This process may be repeated for all rows in section 305.

Construction of a Virtual Slide

In one embodiment, a virtual slide may be generated based on the images obtained during the scanning process. Any one of a number of known techniques may be utilized to combine the images obtained from scanning to produce a virtual slide. In one embodiment, this procedure may be performed using, e.g., specialized software.

Speed Improvement Technique

In one embodiment, the scanning technique described above is performed using constant speed scanning, i.e., the x-y position of stage 14 is adjusted at a constant speed between exposures. Accordingly, stage 14 continues to move without changing speed even during exposures. When constant speed scanning is used, the system may be limited to operating at relatively low speeds to avoid blur in the images produced. Often the top speed allowable under such a limitation is significantly lower than the maximum speed attainable by the system.

In an aspect of the invention, the speed of stage 14 is controlled according to a speed curve that allows higher scanning speeds to be achieved than may be possible using constant-speed scanning. In one embodiment, x-, y-, and z-positions are adjusted according to a speed curve that increases the stage's motion between exposures and slows the motion as the stage approaches a desired imaging position. This technique has the additional benefit of reducing the risk of blur in the images captured during the exposures.

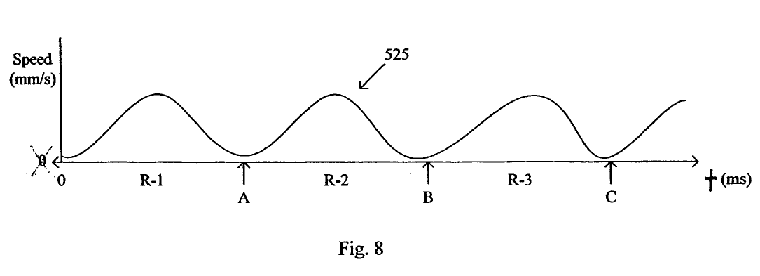

In one embodiment, the stage's motion may be controlled according to a sinusoidal speed curve. FIG. 8 illustrates an example of a speed curve 525 that may be applied to control the x-, y- and z-positions of stage 14. In this illustrative embodiment, points 0, A, B, and C represent an initial position and three desired images positions, separated by regions R-1, R-2, and R-3. Logically, points A, B, and C may be three selected x-y positions, and regions R-1, R-2, and R-3 may be sets containing x-y positions located between the initial position 0 and A, A and B, and B and C, respectively. Thus, as stage 14 moves from the initial position 0 through region R-1 toward imaging position A, it speeds up from an initial speed at initial position 0 to a maximum speed, and then slows down as it approaches imaging position A. When stage 14 arrives at imaging position A, its speed is near zero. An image is captured at imaging position A, and stage 14 again speeds up to a maximum speed as stage 14 moves through region R-2. As stage 14 approaches imaging position B, it again slows down to near zero speed, and an image is captured at imaging position B. The same procedure is repeated with respect to region R-3, imaging position C, etc. Other speed curves may be used in other embodiments.

Compensating for Possible Inaccuracies in Focus Position

In some cases, scanning a target region from a desired-focus position determined in the manner described herein does not produce an optimal image. This may occur for any number of reasons. Intra-field variations on the surface of the sample can cause focus information to be inaccurate. Even when the focus information is accurate, the mechanical nature of the microscope apparatus can cause a scan to produce an out-of-focus image due to mechanical problems, e.g., small motions or vibrations of the apparatus, incorrect calibration, etc.

Accordingly, in an aspect of the invention, uncertainties associated with a desired-focus position are mitigated by generating multiple candidate images of a target region from a plurality of z-positions in the vicinity of the desired-focus position, and selecting from among the candidate images an image of the region having a desired-focus quality. In one embodiment, focus camera 22 scans selected area of a microscope slide in the manner discussed above, multiple overlapping images of a target region are captured, focus information is obtained from the images and a desired-focus position for the region is determined based on the focus information. The desired-focus position is used to determine multiple z-positions, and the region is scanned from each z-position to produce a stack of candidate images of the region. The stack of candidate images is examined, and an image having a desired-focus quality is selected. This procedure may be repeated for designated regions on the microscope slide, and the selected images for the designated regions may be combined to generate a virtual slide.

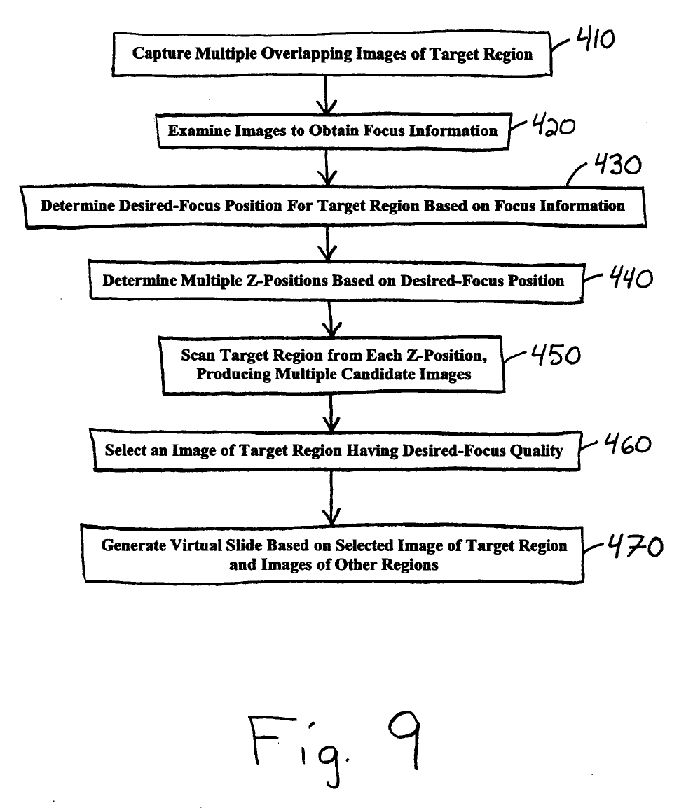

FIG. 9 is a flowchart depicting an example of a method for obtaining images of a microscope slide that compensates for uncertainties associated with focus information, in accordance with another embodiment of the invention. In this embodiment, steps 410-430 are similar to steps 610-630 of FIG. 4. Thus, at step 410, multiple overlapping images of a target region, e.g., region 382, are captured. At step 420, the images are examined and focus information is obtained. Accordingly, each of the images is divided into micro-images corresponding to micro-regions 391-398 within region 382, and stacks of corresponding micro-images, derived from the overlapping images of region 382, are analyzed to determine a desired-focus value for each respective micro-region. At step 430, a desired-focus position for region 382 is determined based on the desired-focus values.

The desired-focus position is used to generate images of region 382. At step 440, multiple z-positions are determined based on the desired-focus position and region 382 is scanned from each of the z-positions, producing at least one candidate image of region 382 from each z-position (step 450). Thus, for example, when region 382 enters scanning window 19, main camera may capture images of region 382 from multiple z-positions. In one embodiment, three z-positions may be determined, including a first z-position equal to the desired-focus position, a second z-position equal to the desired-focus position plus a predetermined offset, and a third z-position equal to the desired-focus position minus the offset. The candidate images are examined, and at step 460 an image of region 382 having a desired-focus quality is selected. This procedure may be repeated for multiple regions on the microscope slide, and the selected images associated with the various regions may be combined to create a virtual slide (step 470).

The foregoing merely illustrates the principles of the invention. It will thus be appreciated that those skilled in the art will be able to devise numerous other arrangements which embody the principles of the invention and are thus within its spirit and scope, which is defined by the claims, below.

1. A method for processing images of a target region on a microscope slide, the method comprising:
capturing one or more images of an area comprising at least a portion of a target region on a microscope slide, each image containing information corresponding to a plurality of focal planes; and
determining a position of a microscope slide for imaging the area, based, at least in part, on the one or more images.

2. The method of claim 1, further comprising capturing an additional image of the at least a portion of the target region based on the position.

3. The method of claim 2, wherein:
the one or more images are captured by a first sensor having a first focal plane;
the additional image is captured by a second sensor having a second focal plane; and
the information corresponds to a plurality of focal planes of the second sensor;
wherein the first sensor is tilted relative to the second focal plane.

4. The method of claim 2, further comprising:
capturing the one or more images by collecting a first portion of the light; and
capturing the additional image by collecting a second portion of the light.

5. The method of claim 4, wherein:
the first portion of the light passes through a first field in a microscope objective; and
the second portion of the light passes through a second field in the microscope objective.

6. The method of claim 5, wherein the first field and the second field are adjacent.

7. The method of claim 5, wherein the first field and the second field are separated by a gap.

8. The method of claim 2, further comprising generating a virtual slide representing the microscope slide based, at least in part, on the additional image.

9. The method of claim 1, wherein the one or more images are captured by collecting light by an image sensor positioned at a non-orthogonal angle relative to an optical axis through the first sensor and the microscope slide.

10. The method of claim 1, further comprising:
analyzing one or more image characteristics at one or more of the focal planes; and
determining the position based, at least in part, on the one or more image characteristics.

11. The method of claim 10, wherein the image characteristics are chosen from the group consisting of texture energy, entropy, contrast, and sharpness.

12. The method of claim 1 wherein:
multiple images of the area are captured at a plurality of locations of the target region.

13. The method of claim 1, wherein the one or more images include at least two overlapping images of the target region.

14. The method of claim 13, wherein capturing the at least two overlapping images comprises:
capturing a first image of at least a part of the area, at a first location of the target region;
adjusting the location of the target region by a predetermined increment smaller than a field of view of the first image; and
capturing a second image partially overlapping the first image at the second location.

15. The method of claim 1, wherein the one or more images are captured during a continuous scan of the microscope slide.

16. The method of claim 15, wherein one or more images of the target region are captured at predetermined intervals during the scan.

17. The method of claim 1, wherein the one or more images are captured during a non-continuous scan of the microscope slide.

18. The method of claim 1, wherein the position is determined by:
identifying multiple sub-regions within the target region;
dividing each of the one or more images into sub-images corresponding to respective sub-regions;
examining one or more of the corresponding sub-images for at least one sub-region to determine a focus value for that respective sub-region; and
determining the position based, at least in part, on one or more focus values of that respective sub-region.

19. The method of claim 18, further comprising:
for that respective sub-region, analyzing one or more image characteristics relating to the one or more corresponding sub-images; and
determining the focus value for that respective sub-region based, at least in part, on the one or more image characteristics.

20. The method of claim 19, further comprising using an interpolation technique to determine the focus value.

21. The method of claim 19, further comprising using a curve-fitting technique to determine the focus value.

22. The method of claim 1, further comprising:
determining one or more additional positions of the microscope slide based, at least in part, on the position;
capturing a second image at the position and at each of the one or more additional positions;
selecting a focused image from among the second images.

23. The method of claim 22, wherein at least one of the additional positions is determined by adjusting the position by a predetermined offset.

24. A system for processing images of a target region on a microscope slide, the system comprising:
means for capturing one or more images of an area comprising at least a portion of a target region on a microscope slide, each image containing information corresponding to a plurality of focal planes; and
means for determining a position of a microscope slide for imaging the area, based at least in part on the one or more images.

25. A system for generating images of a target region on a microscope slide, the system comprising:
a microscope stage to hold a microscope slide;
an objective comprising an objective lens to receive light interacting with the surface of the microscope slide;
a first camera comprising a first image sensor to collect a first portion of the light, the first image sensor having a first focal plane; and
a second camera comprising a second image sensor to collect a second portion of the light, the second image sensor having a second focal plane tilted with respect to the first focal plane.

26. The system of claim 25, further comprising a beam splitter disposed in the path of the light between the objective and the first and second cameras to distribute the first portion of the light to the first camera and the second portion of the light to the second camera.

27. The system of claim 25, wherein the beam splitter distributes the first portion of the light to the first camera and the second portion of the light to the second camera simultaneously.

28. The system of claim 25, wherein a sample to be examined is disposed on the microscope slide.

29. The system of claim 25, further comprising:
a first processor coupled to the first camera; and
a second processor coupled to the second camera;
wherein:
the first processor is programmed to:
cause the first camera to capture a plurality of overlapping images of at least a portion of an area on the microscope slide that includes the target region; and
examine the overlapping images to determine a position for imaging the target region based, at least in part, on information derived from the overlapping images; and
the second processor is programmed to cause the second camera to capture an image of the target region based on the position.

30. The system of claim 29, wherein the first camera is configured to capture images at regular intervals in response to one or more signals generated by one or more encoders.

31. The system of claim 25, wherein an angle of tilt of the second focal plane is achieved by tilting one of the first camera and the second camera relative to an optical axis of the system.

32. A system for generating images of a target region on a microscope slide, the system comprising:
a microscope stage to hold a microscope slide;
an objective comprising an objective lens to receive light interacting with the surface of the microscope slide; and
a camera comprising an image sensor to collect the light, the image sensor being positioned at an oblique angle relative to an optical axis of the system.

33. A system for processing images of a target region on a microscope slide, the system comprising:
a sensor to capture one or more images of an area comprising at least a portion of a target region on a microscope slide, each image containing information corresponding to a plurality of focal planes; and
a processor coupled to the sensor, the processor programmed to determine a position of a microscope slide for imaging the area, based, at least in part, on the one or more images.

34. The system of claim 33, wherein the sensor is tilted relative to an optical axis of the system.

35. The system of claim 33, wherein the first sensor has a first focal plane, further comprising:
a second sensor having a second focal plane tilted relative to the first focal plane to capture an additional image of the target region based on the position.

36. The system of claim 35, wherein the processor is further programmed to examine image data captured from a part of the area corresponding to a selected portion of a field of view of a microscope objective.

37. The system of claim 35, further comprising a second processor coupled to the second sensor, the second processor programmed to cause the second sensor to capture the additional image when the target region corresponds to a second selected portion of the field of view of the microscope objective.

38. The system of claim 35, further comprising:
an objective comprising an objective lens to receive light interacting with the surface of the microscope slide; and
a beam splitter to distribute a first portion of the light to the first sensor and a second portion of the light to the second sensor;
wherein:
the first sensor captures the one or more images by collecting the first portion of the light; and
the second sensor captures the additional image by collecting the second portion of the light.

39. The system of claim 33, wherein the processor is programmed to:
analyze one or more image characteristics at one or more of the focal planes; and
determine the position based, at least in part, on the one or more image characteristics.

40. The system of claim 39, wherein the image characteristics are chosen from the group consisting of texture energy, entropy, contrast, and sharpness.

41. The system of claim 33, wherein the one or more images include at least two overlapping images of the target region.

42. The system of claim 33, wherein the processor is programmed to: identify multiple sub-regions within the target region;
divide each of the one or more images into sub-images corresponding to respective sub-regions;
examine one or more of the corresponding sub-images for at least one sub-region to determine a focus value for that respective sub-region; and
determine the position based, at least in part, on the focus values.

43. The system of claim 42, wherein the processor is further programmed to:
for each sub-region, analyze one or more image characteristics relating to the one or more associated sub-images; and
determine the focus value for the sub-region based, at least in part, on the one or more image characteristics.

44. A method for obtaining images of a plurality of fields on a microscope slide, comprising:
moving at least one of a microscope slide and a microscope objective in accordance with a speed pattern comprising a first non-zero speed attained in association with a first field and a second non-zero speed attained in association with a region between the first field and a second field; and
capturing one or more images of the first field.

45. The method of claim 44, wherein at least one of the one or more images of the first field is captured at the first speed.

46. The method of claim 44, wherein the speed pattern follows a sinusoidal speed curve.

47. The method of claim 44, wherein the first non-zero speed is a minimum in the speed pattern.

48. The method of claim 44, wherein the second non-zero speed is a maximum in the speed pattern.
